(19) United States
(12) Patent Application Publication
(10) Pub. No.: US 2002/0138844 A1
(43) Pub. Date: Sep. 26, 2002

(54) Video-on-demand web portal

(76) Inventors: Rick Otenasek, Bel Air, MD (US); Tobias Joel Musser, Bel Air, MD (US)

Correspondence Address: Law Offices of Royal W. Craig, Suite 153, 10 North Calvert Street, Baltimore, MD, 21202, US

(21) Appl. No.: 10/075,095

(22) Filed: Feb. 12, 2002

Related U.S. Application Data
(60) Provisional application No. 60/268,135, filed on Feb. 13, 2001.

(51) Int. Cl. H04N 7/16; G06F 3/00; H04N 5/445; G06F 13/00; H04N 7/173; G06F 15/16; G06F 15/00; G06F 17/00; G06F 17/21; G06F 17/24; G06T 1/60; G09G 5/00

(52) U.S. Cl. 725/87; 725/25; 725/93; 725/61; 345/731; 345/740; 345/741; 345/760; 707/513; 345/530; 709/219

(57) ABSTRACT

A system for centrally warehousing digital audio/video of PA/LO programs, and for remotely reviewing, authorizing and thereby controlling accessibility of said programs by the public. The system involves a method of use as well as a supporting architecture. The method includes the steps of uploading digital video works from independent producers to a central upload site, tagging each digital video work with an abstract of information, and reviewing and controlling availability of said digital video works for public access from a remote review/control site. The content review/control site serves as a gatekeeper to screen those works that are appropriate for general public access. The architecture includes a central web-enabled server accessible over a distributed communication backbone, and a network administrator for operating the same, the foregoing maintaining a central library of multimedia content. Additionally, a remote content review/control site is maintained by a reviewing authority to remotely review and approve/disapprove each digital video work in central upload site for general public access.

### CROSS-REFERENCE TO RELATED APPLICATIONS

The present application derives priority from U.S. Provisional Patent Application No. 60/268,135, filed: Feb. 12, 2001.

### BACKGROUND OF THE INVENTION

1. Field of the Invention

The present invention relates generally to on-line data libraries and more specifically, to data libraries containing digital audio/video information produced for transmission to the public. In other words, a video-on-demand web site for providing internet access for the uploading/downloading of PA or LO programming that is fully user interactive and inclusive.

2. Description of the Background

The 1984 Cable Act allows municipalities to require cable franchise holders to provide a public access channel and make available equipment, studio space, and technical assistance. The purpose is to avoid monopolization of cable TV by too few sources and to ensure programming of local community interest. Municipalities typically take advantage of this and require that certain cable television channels be set aside for noncommercial, nonprofit organizations and private citizens. This is accomplished in the franchise agreements with each jurisdiction, which specify that certain dedicated channels be set aside to broadcast public access/local origination (PA/LO) programming. The franchise fees shown on the cable TV bills issued to individual households, cable operators, and municipalities are usually applied toward one or more dedicated channels, one or more fully equipped studios to produce PA/LO programs, and free air time for viewing those programs on the aforementioned channel(s).

Unfortunately, the production and viewing of PA/LO has a number of inherent limitations. The construction and maintenance of a production studio and its equipment is very expensive. Public viewing of the PA/LO programs is limited to the dedicated cable channel(s) and available time slots (i.e. scheduling). Often, a general lack of interest exists within the viewing audience due to the limited number of actual programs, and the frequent lack of production quality for those that are aired. Finally, rather than being subject only to FCC regulations, PA/LO programming can become a political hotbed when local authorities attempt to impose their own, more restrictive interpretation of applicable censorship laws.

Technological advances provide some relief from these limitations. For example, production quality is on the increase because many audio/video camera systems, even those for home use, are higher quality digital. In addition, image management and communications systems are evolving from film-based systems toward an all-digital environment where imagery is acquired, transmitted, analyzed, and stored using digital computer and communications technologies. However, the throughput required for communicating digital video is extremely large, consisting of thousands of terabytes of imagery per day. Temporal requirements for capture and dissemination of single images are stringent, ranging from seconds to at most several minutes. Moreover, distribution now entails multiple distribution to geographically distributed users who will require on-demand, interactive access to the data. The underlying network requires the use of multicast protocols to transmit to numerous workstations with differing processing and display capabilities, the data traveling over a heterogeneous network with bandwidths varying by up to six orders of magnitude between the initial down link and the slowest end user. Multicast protocols used for image communications must address several requirements. Setting up a multicast group assigning a multicast group address. All multicast traffic is then delivered to this address, which implies that all members of the group must be listening for traffic with this address. Several existing protocols provide varying levels of support for multicasting, including IP/Multicast, the Xpress Transfer Protocol (XTP), and Experimental Internet Stream Protocol, the Multicast Transport Protocol (MTP), etc. There are significant problems with all of the major multicast protocols for the reliable, adaptive multicast transport of large data items. The problems include inadequate address management, excessive processing of control information, poor response to network congestion, inability to handle high priority traffic, and sub-optimal error recovery and retransmission procedures.

As a result of the foregoing problems, the traditional approach is to maintain large libraries of video files in a large number of geographically dispersed locations in order to provide reasonably rapid access for widely disbursed users. The cost of creation and maintenance of such multiple video libraries, along with the local distribution facilities, is often prohibitive. In addition to the cost, the difficulty in scheduling viewing and managing the local distribution of such videos makes video distribution systems rare and inefficient.

Therefore, there exists a need for an on-line (i.e. internet-accessible) data library of PA/LO programming in order to provide a more public-friendly means for accessing the available information. To fulfill its public access charter, the internet accessible library must truly be user-friendly to encourage widespread access. This should at least include providing access for widely distributed users to upload and view program audio/video online and, where desired, to download the data to the user's remote computer without requiring multi-cast addresses. At the same time there must be a built-in administrative approval process for the resulting content. Applicants are not aware of any existing systems or methods that provide the foregoing capabilities and benefits.

### SUMMARY OF THE INVENTION

It is, therefore, an object of the present invention to provide a process for storing, or warehousing, digital audio/video of PA/LO programs for on-line distribution to the public.

It is still another object to provide a process for uploading/downloading the audio/video data that is user interactive and inclusive.

In accordance with the above objects, the present invention is a system for centrally warehousing digital audio/video of PA/LO programs, and for remotely reviewing, authorizing and thereby controlling accessibility of said programs by the public. The system involves an architecture as well as a method for using the same.

The method for distributed maintenance and publishing control of a library of video files for public access over the internet includes the steps of uploading digital video works from independent producers to a central upload site, tagging each digital video work with an abstract of information including any fields from among the group comprising subject matter category, subject, date, runtime, author, and rating, storing each tagged work with associated abstract in a database on a web-enabled network server, periodically canvassing the abstracts on said network server and compiling a catalog of available works at the server, and maintaining a remote content review/control site for reviewing and controlling availability of said digital video works for public access. The remote content review/control site periodically polls the catalog at the network server to ascertain when new works are available. When a new work is available, the remote content review/control site has the ability to screen each new digital video work by abstract and or by its content in real time by audio/video streaming. The remote content review/control site can thereby approve or disapprove each work for public access viewing over the internet. In this manner, the content review/control site serves as a gatekeeper to screen those works that are appropriate for general public access.

The architecture for supporting the above-described method includes a central web-enabled server accessible over a distributed communication backbone for storing a central library of multimedia content, and a network administrator for maintaining a library of works at the central server and for tagging each new work with an abstract of information and storing the multimedia work with associated abstract in the central library. A catalog of available multimedia works is intermittently and automatically compiled from the abstracts and stored as well on the central server. Additionally, a remote content review/control site is maintained by an administrator (such as a CATV station). The remote content review/control site intermittently polls the catalog maintained on the central server to ascertain when new works have become available. A reviewing authority operates the remote content review/control site and can thereby review and/or edit the abstract of information, view each corresponding work, and approve/disapprove each such work for public access. When a particular work is deemed suitable by the remote content review/control site, a publication approval message is sent to the network administrator indicating that the work should be made available by streaming for general public access.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a flow chart illustrating the interactive process according to the present invention.

FIG. 2 is a network diagram illustrating an exemplary network infrastructure for supporting the preset invention.

FIG. 3 is a flow-chart illustration of the method of the present invention.

FIG. 4 is a screen print of the template by which the Administrator 40 enters the abstract of information.

### DETAILED DESCRIPTION OF THE PREFERRED EMBODIMENT

In accordance with the present invention, a system and method are shown for distributed maintenance and publishing control of a library of video files for public access over the internet in order to provide a real time administrative approval process and, once approved, real time access for widely distributed users.

The present system accomplishes the foregoing by separating network administration from publishing control, resulting in a video library management system (VLMS) that makes video distribution over a wide area network both economically and technically practical. Streaming multimedia file access is provided to users over a wide area network. The VLMS is described herein in the particular context of a public access video solution that provides a forum to exhibit the creative efforts of the independent film maker, video maker, musician and/or artist.

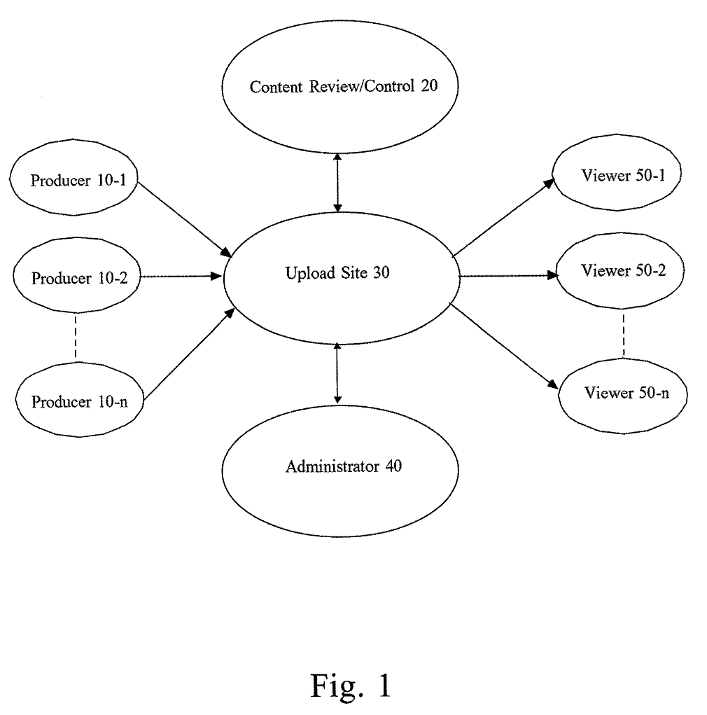

In the above-described context of a public access video solution, the system implements the communication flow diagram of FIG. 1. Generally, independent film makers, video makers, musicians and/or artists (“producers”) 10-1 . . . n independently develop multimedia content. If they choose to submit their work for public access distribution over the VLMS, they must send or upload their content to a central upload site 30. A network Administrator 40 maintains a library of the multimedia content at the central upload site 30. This maintenance function includes tagging each work with an abstract of information and storing the work with associated abstract in a central library. A catalog of available works in the library is intermittently compiled from the abstracts, and the catalog is maintained at the central upload site 30.

A reviewing authority such as the cable television company operates a remote content review/control site 20 by which they review and, if necessary, edit the abstract of information, view the submitted works, and approve/disapprove each such work for public access. The remote content review/control site 20 intermittently polls the catalog maintained by the network Administrator 40 at the central upload site 30 to ascertain when new works have become available. The remote content review/control site 20 can physically be any computer (or network of computers) with web access and proper authorization. Based on the abstracted information in the catalog, the content review/control site 20 is able to screen and approve/disapprove each video or other submission by producers 10, edit the abstract, specify a viewer rating, and fully review the content of each work if necessary, thereby acting as a gatekeeper to screen those works that are appropriate for general public access. If a particular work is deemed suitable, a publication approval message is sent to Administrator 40 and the work is made available for public access by the Administrator 40. All existing media content is centrally stored by Administrator 40, but is available in real time to content review/control site 20 and by streaming to each viewer 50-1 . . . n once approved by content review/control site 20.

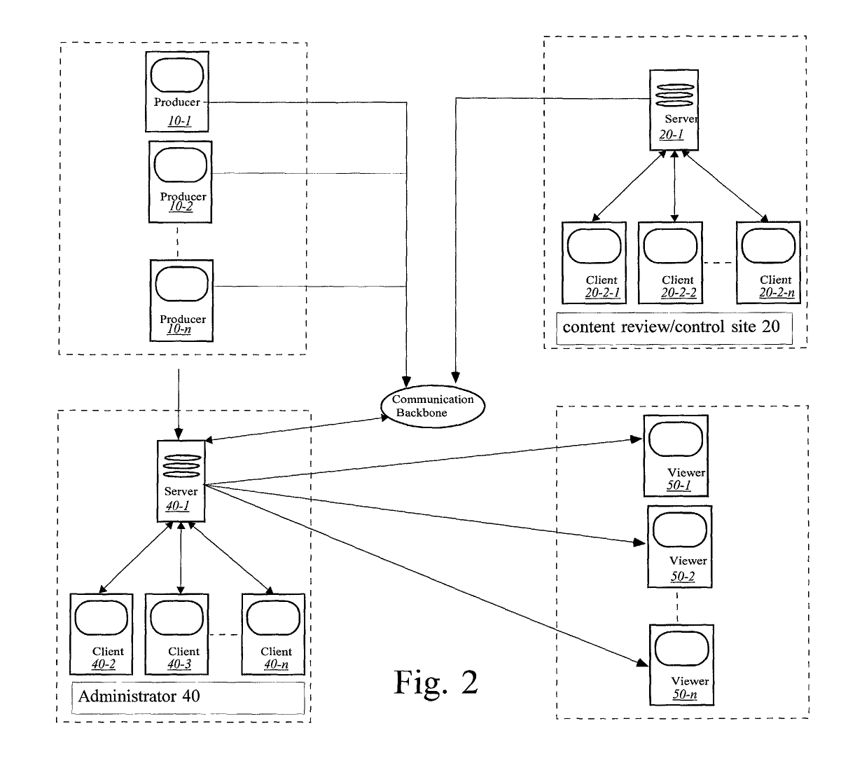

FIG. 2 is a network diagram illustrating an exemplary network infrastructure for supporting the method of the present invention. The above-described participants are given seamless point-to-multipoint communication capabilities within the network, and the infrastructure integrates multi-media streaming capabilities into the computer communication process by packet-based communication. The producers 10-1 . . . n upload artistic works to Administrator site 40 either manually or by computer. After digitalization (if necessary), the Administrator 40 adds the media file to a dynamic database of such files resident on the central upload server 40-1 of Administrator station 40. The database is structured to tag the multimedia file with a template of abstract information to be entered by the Administrator 40. The database may be an SQL database created with conventional SQL server software. The remote content review/control site 20 will be manned by a cable television company having an in-house LAN with server 20-1 and multiple employees authorized to serve as approval authorities each with web access via a client station 20-2 . . . n, and each with a distinct login identification and password. The remote content review/control site 20 intermittently polls the catalog maintained by the network Administrator 40 to ascertain when new works are available. Based on the abstracted information in the catalog, the content review/control site 20 is able to screen each video or other submission by producers 10, fully review each work if necessary, and act as gatekeeper, screening those works that are appropriate for general public access. If a particular work is deemed suitable, the remote content review/control site 20 sends a publication approval message back to Administrator 40 and the work is made available for public access by the Administrator 40. All existing media content is available in real time to the content review/control site 20 and by streaming to each viewer 50-1 . . . n (contingent on approval by content review/control site 20). Streaming video is a sequence of “moving images” that are sent in compressed form over the Internet and displayed by the viewer as they arrive. With streaming media, a Web user does not have to wait to download a large file before seeing the video or hearing the sound. Instead, the media is sent in a continuous stream and is played as it arrives. Both viewer 50 and content reviewer 20 are loaded with a software player for streaming video. The player can be either an integral part of their existing browser software or a standalone program. Either way, a variety of players are readily commercially available. Major streaming video and streaming media technologies include RealSystem G2 from RealNetwork, Microsoft Windows Media Technologies (including its NetShow Services and Theater Server), and VDO. Microsoft's technology offers streaming audio at up to 96 Kbps and streaming video at up to 8 Mbps (for the NetShow Theater Server). However, for most Web users, the streaming video will be limited to the data rates of the connection (for example, up to 128 Kbps with an ISDN connection). Microsoft's streaming media files are in its Advanced Streaming Format (ASF, WMA, WMV).

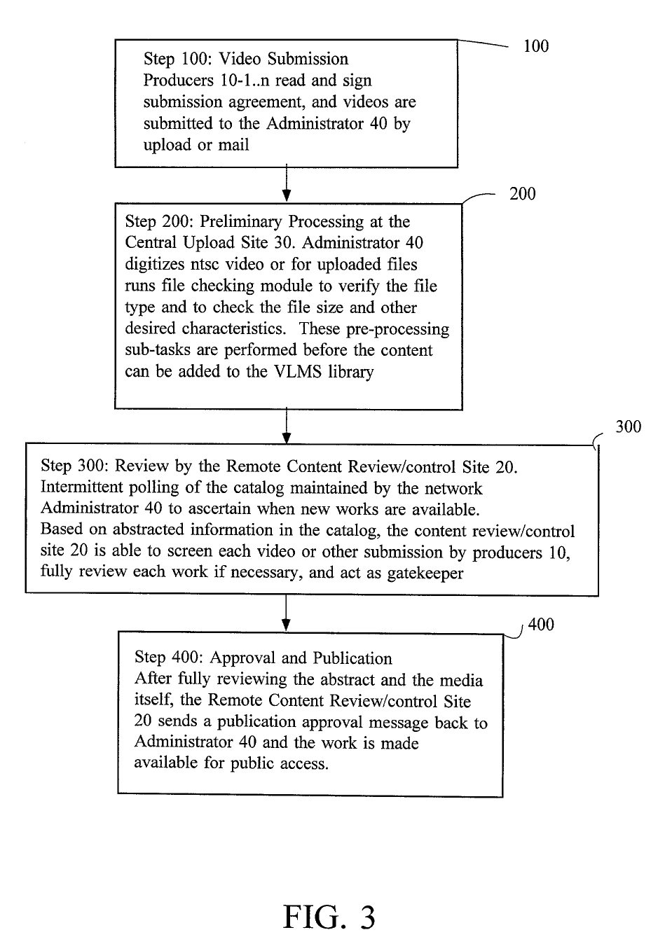

A more detailed explanation of the salient steps in the above-described process follows with reference to FIG. 3, which is a flow-chart illustration of the method of the present invention.

Step 100: Video Submission

In order to submit video and/or other media material to the Administrator 40, each producer must read and sign a waiver agreement that gives permission to the station to make the material available for viewing and for broadcast over the Internet without any rights or expectations to privacy in the material. The agreement will also indemnify the station against the wrongful acts of the producer, such as copyright infringement. The producer 10 either signs the foregoing agreement and sends a physical copy of the videotape, or logs onto the Administrator server 40-1, fills the electronic equivalent of the form.

Once the form is completed, the producers 10-1 . . . n may upload artistic works to Administrator site 40 either manually or by computer. If manually, a video tape is mailed in accordance with a specified protocol described to the producers. The video tape in NTSC format is then digitized by Administrator 40 and stored on the central upload server 40-1 using conventional digital imaging equipment and a high-speed digital capture program. For example, Pinnacle Systems offers the miro VIDEO DC50 broadcast quality composite to analog input and output video capture. The digital video is preferably stored in advanced video imaging format (AVI).

If, instead, the media is uploaded in digital form this can be accomplished over the network of FIG. 1 by standard file transfer. To accomplish this, the Administrator server 40-1 preferably uses the built in file upload features of the Microsoft IIS server (if the system is implemented on another platform, such as Apache or Websphere, each has an upload counterpart feature). These upload capabilities are not standard file transfer protocol (FTP), but a true port upload so as to avoid any firewall issues. All file security may be set by the administrator at the Administrator server 40-1 (including all access, approval required, no access, etc.). These capabilities are graphically integrated Internet Explorer® and Netscape® extension, thereby giving producers 10-1 . . . n the ability to accomplish their own upload without any need for any technical knowledge of FTP or other protocols.

Step 200: Preliminary Processing at the Central Upload Site 30

Once the upload session is complete and the file has been uploaded directly to the Central Upload Site 30, a variety of pre-processing sub-tasks are performed before the content can be added to the VLMS library. First of all, for uploaded files the Administrator 40 runs a file checking module to verify the file type and to check the file size and other desired characteristics. The system accepts any compressed video file type for recompression/translation, and the files can be stored in the library in any such format (MPG, MOV, AVI, RM). Presently, files are stored in the VLMS in AVI format. The file checking module also has the ability to screen uploaded files by file size, extension or name. When a file is verified as valid, the checking module spawns a COM (Component Object Modal) function to whichever industry file encoder is needed (IE REAL, Windows Media, QuickTime, AVI, or any future encoding standard. After encoding the file in a uniform format such as AVI (or other), it is added to the VLMS database of files needing approval, and an administrative alert is sent to the Administrator 40 based on any method selected by the administrator (Page, Email, none).

Once the uploaded file has been screened and/or converted to the proper format at the central upload site 30 or, alternatively, a mailed video has been digitized accordingly, the Administrator 40 adds the media file to a dynamic database of such files resident on the central upload server 40-1 of Administrator station 40. The database may be an SQL database created with any conventional SQL server software. For example, Microsoft SQL Server 7.0 software can be used. It is also important to note that the system works on any conventional web hosting platform, including Apache, IIS, and Netscape servers.

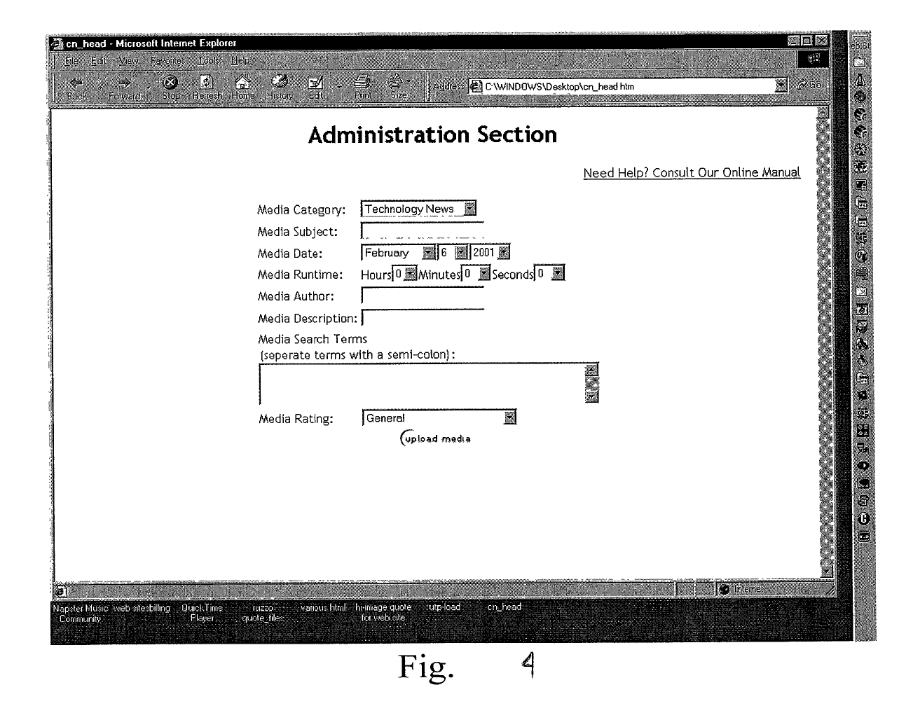

The database is structured to allow the Administrator 40 to tag the multimedia file with a template of abstract information. FIG. 4 is a screen print of the template by which the Administrator 40 enters the abstract of information. The template preferably includes data entry fields for Media Category, Media Subject, Media Date, Media Runtime, Media Author, and Media Rating. The Media Category, Media Date, Media Runtime and Media Rating fields are preferably drop-down selection boxes with pre-defined categorical selection choices. In addition, the template includes a keyword entry field to allow the Administrator to search the abstracts in the database for abstract records matching a specified query. After making the appropriate selections and entries, the Administrator 40 stores the work with associated abstract in the database on server 40-1. A catalog of available works in the library is intermittently compiled from the abstracts.

Step 300: Review by the Remote Content Review/control Site 20

The Remote Content Review/control Site 20 is a web portal accessible by authorized content reviewers and capable of communicating with the database engine running on a structured query language (SQL) server at the Administrator's site 40. Thus, the remote content review/control site 20 can physically be any computer with web access and proper authorization. Typically, in the public access video context, the remote content review/control site 20 will be manned by a cable television company having an in-house LAN with server 20-1 and multiple employees authorized to serve as approval authorities each with web access via a client station 20-2 . . . n, and each with a distinct login identification and password. The remote content review/control site 20 intermittently polls the catalog maintained by the network Administrator 40 to ascertain when new works are available. Based on the abstracted information in the catalog, the content review/control site 20 is able to screen each video or other submission by producers 10, fully review each work if necessary, and act as gatekeeper, screening those works that are appropriate for general public access. At the reviewer client stations 20-2-1 . . . n, each content reviewer is presented with a graphical interface with the following menu options:

Enable/Disable Site

Add a Media Category (The Remote Content Review/control Site 20 can designate a new category description, and then subsequently assign videos to that category for ease of management and searching).

View Media Pending Approval

Edit Approved/Unapproved Media (This option calls up an interface that allows the Remote Content Review/control Site 20 to make any final changes deemed necessary to make the media “approvable”.

Choose Top Stories (This option allows the Remote Content Review/control Site 20 to designate which media file(s) will be showcased on user-accessible web pages corresponding to the designated media categories, as well as an overall homepage for the public access library. Any given designation may appear on the homepage and/or embedded category page as an advertisement for and/or link directly to the designated media file.

If the content reviewer chooses “View Media Pending Approval” a list of the newly available media file(s) appears. The list is taken directly from the catalog of available that is compiled from the abstracts entered by Administrator 40. By selecting any given work on the list of the newly available media file(s), the Remote Content Review/control Site 20 is presented with the same template depicted in FIG. 4. This allows the Remote Content Review/control Site 20 to enter and/or edit previously entered information for any of the pre-defined data entry fields. By depressing the >Upload Media button, the Remote Content Review/control Site 20 dynamically pulls the media off of the Administrative server 40-1 through standard TCP/IP protocols, and the media is streamed directly to the Remote Content Review/control Site 20 and is displayed in a second standard browser window or software media player as described in the next section. As before, this may be accomplished within Internet Explorer®, thereby eliminating the need for any technical knowledge on the part of the Remote Content Review/Control Site 20. Finally, the Remote Content Review/Control Site 20 can select an appropriate Media Rating (e.g., R, PG-13, PG, G, etc.) from the drop-down window and this is attached to the abstract record.

Step 400: Approval and Publication

After fully reviewing the abstract and the media itself, the content reviewer at the Remote Content Review/control Site 20 simply clicks an approval button. By this action, the remote content review/control site 20 sends a publication approval message back to Administrator 40 and the work is made available for public access. All approved media content is centrally stored by Administrator 40, but is available in real time to content review/control site 20 and by streaming to each viewer 50-1 . . . n.

The turn-around time from upload/approval/publishing can be as little as the upload time of the media. This is dependant on the speed of the internet connection provided to the upload workstation. A typical High speed line will upload 5 minutes of video in about 40 seconds (T1). In reality, data is collected by a dynamic database form, uploaded to an approval site, and then published, all within a period typically less than 5 minutes.

The combination of features used in the present invention provides an efficient strategy for accessing video files from one video file library and delivering those video files to a widely distributed geographical area at a reasonable cost over a relatively slow wide area network.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth herein.

We claim:

1. A system for distributed maintenance and publishing control of a library of video files for public access over the internet, comprising:
a central server accessible over a distributed communication backbone for storing a central library of multimedia content;
a network administrator for maintaining said library of multimedia content at the central server, said maintenance including tagging each work with an abstract of information and storing the multimedia work with associated abstract in said central library;
a catalog of available multimedia works intermittently compiled from the abstracts and stored on said central server;
a remote content review/control site that intermittently polls the catalog maintained on the central server to ascertain when new works have become available, said remote content review/control site allowing a reviewer to edit the abstract of information and view each corresponding work, and to approve/disapprove each such work for public access;
whereby when a particular work is deemed suitable by the remote content review/control site, a publication approval message is sent to the network administrator indicating that the work should be made available by streaming for general public access.

2. The system for distributed maintenance and publishing control of a library of video files for public access over the internet according to claim 1, wherein said library of multimedia content at the central server is maintained in an SQL database.

3. The system for distributed maintenance and publishing control of a library of video files for public access over the internet according to claim 1, wherein said library of multimedia content at the central server is maintained in a uniform digital video format.

4. The system for distributed maintenance and publishing control of a library of video files for public access over the internet according to claim 1, wherein said library of multimedia content at the central server is maintained in AVI digital format.

5. A method for distributed maintenance and publishing control of a library of video files for public access over the internet, comprising the steps of:
providing a web portal to independent video producers by which they can upload their video files to a central upload site;
performing pre-processing on each video file uploaded to said central upload site, said pre-processing including verification of a video file format, screening based on file size, translation when necessary to a uniform pre-determined file format, tagging each file added to said database with an abstract of information, and storage of each pre-processed file in a database of files needing approval;
sending an administrative alert for each file added to said database to an administrator;
maintaining a catalog at said central upload site of all new tagged files in said database;
periodically canvassing said catalog from a remote reviewing site, and for each new tagged file in said database, reviewing the abstract and content of the tagged file as desired and sending a publication approval or disapproval message back to the administrator at the central upload site.

6. The method for distributed maintenance and publishing control of a library of video files for public access over the internet according to claim 5, wherein said step of storing each pre-processed file in a database of files needing approval further comprises storing each pre-processed file in an SQL database library of multimedia content at the central upload site.

7. The method for distributed maintenance and publishing control of a library of video files for public access over the internet according to claim 6, wherein said step of storing each pre-processed file in a database of files needing approval further comprises storing each pre-processed file in a uniform digital video format.

8. The method for distributed maintenance and publishing control of a library of video files for public access over the internet according to claim 7, wherein said step of storing each pre-processed file in a database of files needing approval further comprises storing each pre-processed file in AVI digital format.

9. A method for distributed maintenance and publishing control of a library of video files for public access over the internet, comprising the steps of:
uploading digital video works from independent producers to a central upload site;
tagging each digital video work with an abstract of information including any fields from among the group comprising subject matter category, subject, date, runtime, author, and rating;
storing each tagged work with associated abstract in a database on a web-enabled network server;
periodically canvassing the abstracts on said network server and compiling a catalog of available works at said network server;
maintaining a remote content review/control site for reviewing and controlling availability of said digital video works for public access, said remote content review/control site periodically polling said catalog at the network server to ascertain when new works are available, and said remote content review/control site having the ability to screen each new digital video work by abstract and by content in real time by audio/video streaming, and to approve/disapprove each said work for public access viewing, whereby said content review/control site serves as a gatekeeper to screen those works that are appropriate for general public access.

10. The method for distributed maintenance and publishing control of a library of video files for public access over the internet according to claim 9, further comprising a step of receiving mailed NTSC videos and digitizing said NTSC videos into digital video works at said central upload site.

11. The method for distributed maintenance and publishing control of a library of video files for public access over the internet according to claim 9, further comprising the step of providing streaming video access to all works approved by said review/control site for public access viewing.
